(19) United States
(12) Patent Application Publication
(10) Pub. No.: US 2014/0124334 A1
(43) Pub. Date: May 8, 2014

(54) MEDIUM CONVEYANCE APPARATUS

(71) Applicant: Shinji Sado, Gumma (JP)

(72) Inventor: Shinji Sado, Gumma (JP)

(73) Assignee: OKI ELECTRIC INDUSTRY CO., LTD., Tokyo (JP)

(21) Appl. No.: 14/130,248

(22) PCT Filed: Jun. 14, 2012
(86) PCT No.: PCT/JP2012/065219

§ 371 Date: Dec. 30, 2013

(30) Foreign Application Priority Data
Sep. 21, 2011 (JP) 2011-206113

(51) Int. Cl. B65G 13/02

(52) U.S. Cl. CPC B65G 13/02
USPC 198/604

(57) ABSTRACT

A medium conveyance apparatus includes a conveyance roller, a pinch roller and a pinch roller spring. The pinch roller includes a pinch roller shaft and a bearing. The pinch roller shaft has a flat surface formed thereon to be made in contact with a spring flat surface of the pinch roller spring, thereby preventing the pinch roller shaft from rotating together with the bearing.

### TECHNICAL FIELD

The present invention relates to a medium conveyance apparatus and a medium transaction device, and, for example, to an apparatus, such as an automatic teller machine (ATM), which receives a medium, such as cash, and conducts desired transactions.

### BACKGROUND ART

Automatic teller machines for use in banking facilities or the like are so constituted that the customer is invited, in accordance with a transaction content with the customer, to deposit cash, such as bills and coins, and to deliver cash to the customer.

For example, Japanese patent laid-open publication No. 2011-2921 shows in FIG. 1 an automatic teller machine which includes a bill deposit/withdrawal opening for payment and receipt of bills; a discriminator which determines the validity and the denominations of bills; a temporary storage which temporarily stores bills; and cassettes which store bills denomination by denomination.

Such an automatic teller machine uses, as shown in FIG. 23, a roller conveyance channel 2020 which conveys the bills, for example. The roller conveyance channel 2020 includes a conveyance roller 34 provided rotatably, a pinch roller 2036 which is disposed above the conveyance roller 34 so as to contact therewith to push a bill BL to the conveyance roller 34, and a pinch roller rail 52 which has its lateral side U-shaped. Between the conveyance roller 34 and the pinch roller 2036, the bill BL is conveyed, for example, toward the right from the left in the figure, as indicated by an arrow B.

The pinch roller 2036 is adapted for pushing the bill BL onto the conveyance roller 34 when the bill BL passes between the conveyance roller 34 and the pinch rollers 2036, and comprises a cylindrical pinch roller shaft 2038 parallel to the rotation shaft of the conveyance roller 34, and a bearing 40 which is rotatable about the pinch roller shaft 2038 as an axis of the rotation.

The pinch roller shaft 2038 is the rotation axis of the pinch roller 2036, and is adapted for supporting the bearing 40 so as to push the outer periphery of the bearing 40 onto the conveyance roller 34. In FIG. 23, the pinch roller shaft 2038 contacts a pinch roller spring 56 at its upper end, and receives spring energizing force FSP from the pinch roller spring 56. Further, the pinch roller shaft 2038 extends along the pinch roller rail 52, and is slidable in a shaft movable direction 2040. In FIG. 23, the shaft movable direction 2040 is substantially vertical. Accordingly, when the pinch roller shaft 2038 is urged toward the conveyance roller 34 by the spring urging force FSP provided by the pinch roller spring 56, it moves downward on the pinch roller rail 52, and pushes the outer periphery of the bearing 40 onto the outer periphery of the conveyance roller 34.

Hitherto, in the pinch roller 2036, a metal roller bearing 700 as shown in FIG. 24 is used as the bearing 40. FIG. 24 exemplarily shows a schematic structure of a roller bearing 700. As shown in FIG. 24, the roller bearing 700 is configured by a metal outer ring 70 and an inner ring 72, and a plurality of spherical rolling elements 76 which are inserted between the outer ring 70 and inner ring 72, and are held in predetermined positions by a retainer 74. In order to rotate the rolling elements 76 smoothly, a grease, not shown, is enclosed in the roller bearing.

However, according to the roller bearing 700, the grease might leak out and might adhere to bills BL. In addition, the metal outer ring 70 might rust and the rust might adhere to bills BL.

Therefore, instead of the roller bearing 700, a slide bearing 800 made of resin as shown in FIG. 25 has become adopted. The slide bearing 800 is molded into one piece. Accordingly, since the slide bearing 800 does not use grease or the like, there is no possibility of getting bills BL dirty.

However, in comparison with the roller bearing 700, the slide bearing 800 has a problem that the slide bearing easily transfers its torque to the pinch roller shaft 2038. Describing in detail, as shown in FIG. 23, when a bill BL is conveyed on the roller conveyance channel 2020, the bearing 40 of the pinch roller 2036 is pushed onto the conveyance roller 34 to rotate according to its rotation. With a pinch roller 2036 using the roller bearing 700 as the bearing 40, the bearing 700 has its torque causing rolling force for the rolling elements 76 inside the roller bearing 700, and therefore the transmitting ratio of the torque to the inner ring 72 is small. On the other hand, with a pinch roller 2036 using the slide bearing 800 as the bearing 40, torque transmitted from the conveyance roller 34 is directly transmitted to the inner periphery of the bearing 800. Since the inner periphery of the bearing 800 is in contact with outer periphery of the pinch roller shaft 2038, torque transmitted to the inner periphery of the bearing 800 is transmitted to the pinch roller shaft 2038 by friction between the inner periphery of the bearing 800 and the outer periphery of the pinch roller shaft 2038, and this causes a rotation of the pinch roller shaft 2038.

When the pinch roller shaft 2038 rotates in this way, since the pinch roller shaft 2038 has its shape cylindrical, friction occurs between the upper end of the pinch roller shaft 2038 and the pinch roller spring 56 as well as friction occurs between the side edges of the pinch roller shaft 2038 and the pinch roller rail 52. As a result, the pinch roller rail 52 is worn out and becomes uneven, and it becomes difficult for the pinch roller shaft 2038 to slide on the pinch roller rail 52. Thus, conveyance force of bills BL in the roller conveyance channel 2020 becomes unstable, and there is a possibility that poor conveyance might occur.

### SUMMARY OF THE INVENTION

It is an object of the present invention to provide a medium conveyance apparatus and a medium transaction apparatus which can overcome the difficulties in the conventional art to prevent poor conveyance of a medium, thus improving reliability.

A medium conveyance apparatus according to the present invention comprises: a conveyance roller rotating while touching a medium to move the medium in a plane direction; a pinch roller shaft arranged substantially in parallel to the rotation shaft of the conveyance roller to move in a shaft movable direction; a bearing provided on the outer circumference of the pinch roller shaft and touching the medium from the side opposite to the conveyance roller to rotate while the conveyance roller rotates; and a shaft rotation suppression element suppressing the pinch roller shaft from rotating together with the bearing. Accordingly, when torque is transmitted to the pinch roller shaft from the bearing, the medium conveyance apparatus according to the present invention causes the shaft rotation suppression element to prevent the pinch roller shaft from rotating.

A medium transaction apparatus according to the present invention comprises: a reception section receiving a transaction on a medium; a conveyance channel conveying the medium received by the reception section; a conveyance roller rotating while touching the medium to move the medium in a plane direction; a pinch roller shaft arranged substantially in parallel to the rotation shaft of the conveyance roller to move in a shaft movable direction; a bearing provided on the outer circumference of the pinch roller shaft and touching the medium from the side opposite to the conveyance roller to rotate while the conveyance roller rotates; and a shaft rotation suppression element suppressing the pinch roller shaft from rotating together with the bearing. Accordingly, when torque is transmitted to the pinch roller shaft from the bearing, the medium transaction apparatus according to the present invention causes the shaft rotation suppression element to prevent the pinch roller shaft from rotating.

According to the present invention, when torque is transmitted to a shaft from a bearing, a shaft rotation suppression element can prevent the shaft from rotating. Accordingly, the present invention can implement a medium conveyance apparatus and a medium transaction apparatus which can prevent poor conveyance of a medium and remarkably improve the reliability.

### BRIEF DESCRIPTION OF THE DRAWINGS

The objects and features of the present invention will become more apparent from consideration of the following detailed description taken in conjunction with the accompanying drawings in which:

FIG. 1 is a perspective view schematically showing the appearance structure of an automatic teller machine according to first through seventh embodiments;

FIG. 2 is an explanatory diagram schematically showing the internal structure of the automatic teller machine according to the first through seventh embodiments;

FIG. 3 is a side view schematically showing the structure of a roller conveyance channel according to the first through seventh embodiments;

FIG. 4 is a top view schematically showing the structure of the roller conveyance channel shown in FIG. 3;

FIG. 5 is a perspective view schematically showing the structure of a pinch roller for use in the roller conveyance channel shown in FIG. 3;

FIG. 6 is a side view schematically showing an example of an alternative structure of the roller conveyance channel according to the first embodiment;

FIG. 7 is a side view schematically showing an example of a further alternative structure of the roller conveyance channel according to the first embodiment;

FIG. 8 is a side view schematically showing the structure of a roller conveyance channel according to the second and third embodiments;

FIG. 9 is a side view schematically showing the structure of a pinch roller according to the second embodiment;

FIG. 10 is a side view schematically showing the structure of a pinch roller according to the third embodiment;

FIG. 11 is a side view schematically showing the structure of a roller conveyance channel according to the fourth embodiment;

FIG. 12 is a side view schematically showing the structure of a pinch roller according to the fourth embodiment;

FIG. 13 is a side view schematically showing the structure of a roller conveyance channel according to the fifth embodiment;

FIG. 14 is a side view schematically showing an alternative structure of the roller conveyance channel according to the fifth embodiment;

FIG. 15 is a side view schematically showing a further alternative structure of the roller conveyance channel according to the fifth embodiment;

FIG. 16 is a side view schematically showing the structure of a roller conveyance channel according to the sixth embodiment;

FIG. 17 is a side view schematically showing the structure of a roller conveyance channel according to the seventh embodiment;

FIG. 18 is a side view schematically showing an alternative structure of the roller conveyance channel according to the seventh embodiment;

FIG. 19 is a side view schematically showing the structure of a roller conveyance channel according to the present invention;

FIG. 20 is a perspective view schematically showing a structure including pinch rollers and conveyance rollers according to the present invention;

FIG. 21 is a top view schematically showing the structure of a conveyance channel which uses the pinch rollers and the conveyance rollers shown in FIG. 20;

FIG. 22 is a perspective view schematically showing an alternative structure including pinch rollers and conveyance rollers according to the present invention;

FIG. 23 is a side view schematically showing the structure of a conventional roller conveyance channel;

FIG. 24 exemplarily shows a schematic structure of a roller bearing; and

FIG. 25 is a side view schematically showing the structure of a conventional pinch roller.

### BEST MODE FOR IMPLEMENTING THE INVENTION

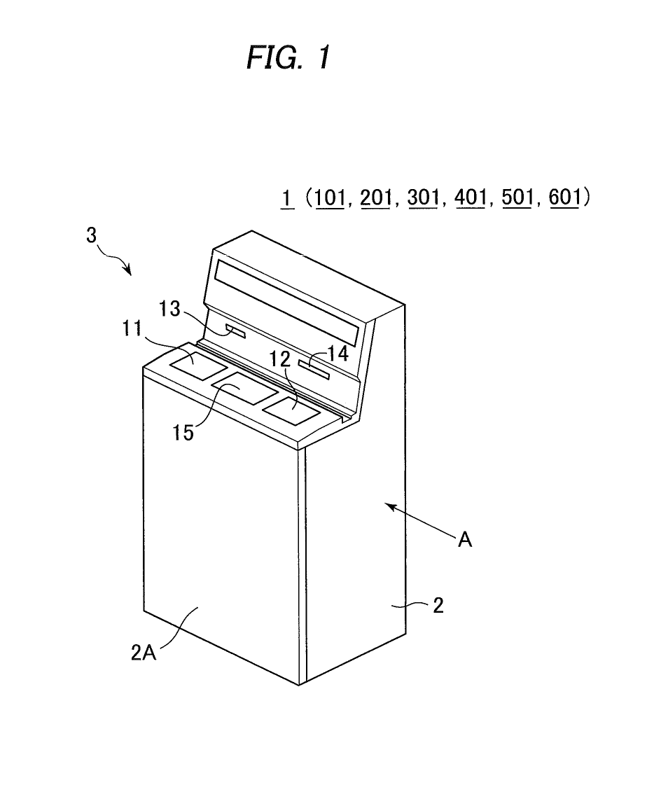

Next, with reference to the accompanying drawings, a medium conveyance apparatus and a medium transaction apparatus according to the present invention will be described in detail. FIG. 1 shows an automatic teller machine 1 as an embodiment of the medium conveyance apparatus and a medium transaction apparatus according to the present invention. The automatic teller machine 1 conducts transactions regarding cash with customers, and has its exterior generally constituted by a box-like casing 2.

The casing 2 is provided with a customer section 3 which is provided in a position where the customer is easy to deposit bills and to operate a touch panel and the like when he or she faces the automatic teller machine 1, and which is, in the present embodiment, provided above the front surface 2A of the casing 2.

The customer section 3 is a component for receiving and delivering cash and a bankbook between the customer and the automatic teller machine 1, and for notifying information on transactions and receiving operation instructions. In the present embodiment, the customer section 3 is provided with a coin deposit/withdrawal opening 11, a bill deposit/withdrawal opening 12, a bankbook slot 13, a card slot 14, and a display and operating section 15.

The coin deposit/withdrawal opening 11 and the bill deposit/withdrawal opening 12 are components which coins and bills are inserted into and discharged from, respectively, so that coins and bills are inserted thereinto by the customer respectively and coins and bills are discharged therefrom to him or her respectively. In the present embodiment, the coin deposit/withdrawal opening 11 and the bill deposit/withdrawal opening 12 are provided with respective shutters, which are driven to open or close the withdrawal openings 11 and 12.

The bankbook slot 13 is a component into which a bankbook to be used in transactions is inserted, and from which the bankbook is discharged after transactions are completed between the customer and the automatic teller machines 1. A bankbook processing unit (not shown) which records transaction content and the like on the bankbook is provided at the back of bankbook slot 13.

The card slot 14 is a component for receiving and discharging a various type of card, such as an ATM card for use in transactions. A card processing unit (not shown) which reads out an account number and the like magnetically recorded on a card is provided at the back of the card slot 14.

The display and operating section 15 is adapted to present information on transactions to the customer and to which he or she inputs a type of transaction, a passcode, transaction money amount and the like. In the present embodiment, the display and operating section 15 comprises a liquid crystal display (LCD) and a touch panel, which are integrated into unit.

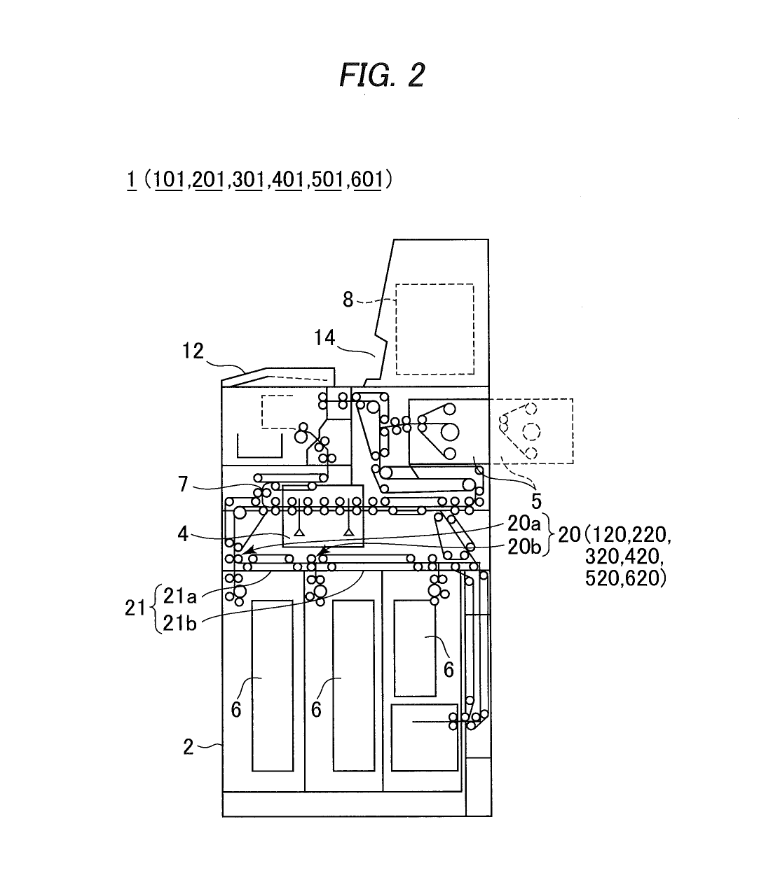

FIG. 2 is a sectional side view of the automatic teller machine 1 when viewing the automatic teller machine 1 of FIG. 1 from the direction indicated by an arrow A, and mainly shows components regarding processing of bills in the internal structure of the automatic teller machine 1. As shown in FIG. 2, inside the automatic teller machine 1, a discriminator 4 and a temporary storage 5 are provided in the upper portion, a bill storage 6 is provided in the lower portion, and a conveyance channel 7 is provided so as to connect those components. In FIG. 2, the conveyance channel 7 is depicted with a medium-thick line.

The discriminator 4 is adapted to determine the validity and denominations of bills, and the temporary storage 5 is adapted to temporarily store deposit bills. The bill storage 6 is for use in storing bills, and comprises, in the present embodiment, cassettes specific for respective denominations.

The conveyance channel 7 is adapted for conveying bills between the components. In the present embodiment, the conveyance channel 7 comprises belt conveyance channels 21 (21a, 21b . . . ) and roller conveyance channels 20 (21a, 20b . . . ) to convey bills with the shorter side thereof rendered in parallel to the conveying direction. Although the automatic cash dispenser 1 includes a lot of belt and roller conveyance channels like the channels 21 and 20 in, FIG. 2 shows only some of them designated with the reference numerals.

The belt conveyance channels 21 are adapted to convey bills, which, in the present embodiment, will be transferred by tapes. Specifically, each belt conveyance channel 21 is provided with a couple of tapes each of which is wound over a pair of rollers arranged opposite to each other, so that the couple of tapes carry bills in between to convey the bills.

The roller conveyance channels 20 are mainly provided between adjacent ones of the belt conveyance channels 21, like a roller conveyance channel 20b provided between belt conveyance channels 21a and 21b, and are adapted for pinching bills by pinch rollers and conveyance rollers to convey them, which will be described later.

The automatic teller machine 1 thus configured is generally controlled by a controller 8. For example, in the case when the transaction is a deposit of bills, the controller 8 accepts a predetermined operation input through the display and operating section 15; opens the shutter of the bill deposit/withdrawal opening 12 to prompt the customer to insert bills; conveys the inserted bills to the discriminator 4 on the conveyance channel 7 to cause the discriminator 4 to determine the validity of the received bills; and conveys the bills, when determined as normal bills by the discriminator 4, to the temporary storage 5 to temporarily reserve the bills therein; whereas it conveys a rejected bill determined inappropriate for the transaction toward the bill deposit/withdrawal opening 12 to return it to the customer.

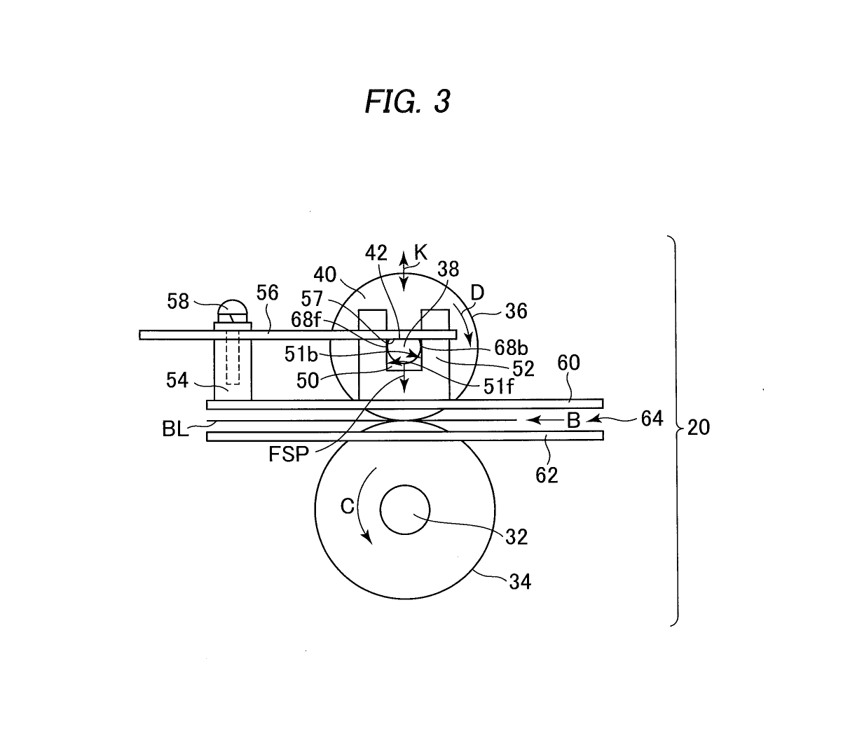

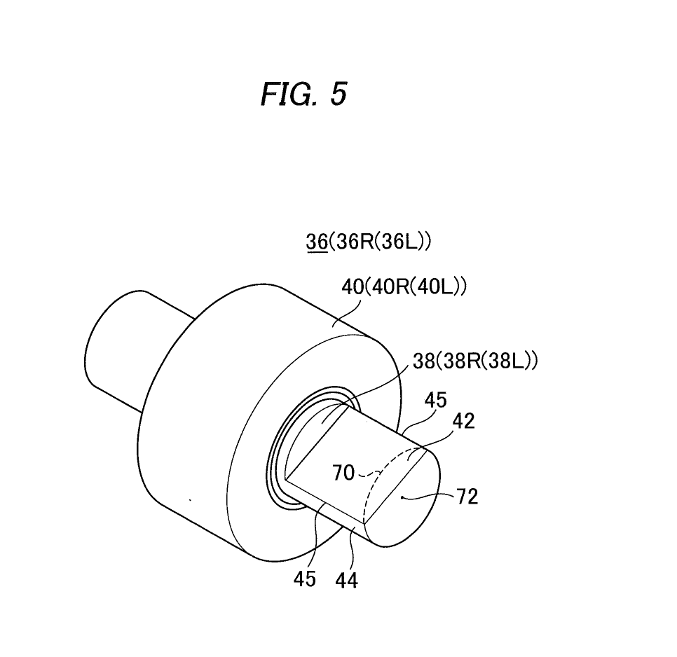

With reference to FIGS. 3 to 5, the roller conveyance channel 20 will be described in detail. In FIGS. 3 and 5, two pinch rollers arranged on the right and the left are collectively illustrated as a single roller on the roller conveyance channel 20. In FIG. 3, the left side of the figure corresponds to the front surface side (hereinafter, simply referred to as front side or front also) of the automatic teller machine 1, and the right side of the figure is a back surface side (hereinafter, simply referred to as a backside or back also) of the automatic teller machine 1. Common or like components in the figures are designated by the same reference numerals, and redundant description thereon will be refrained from.

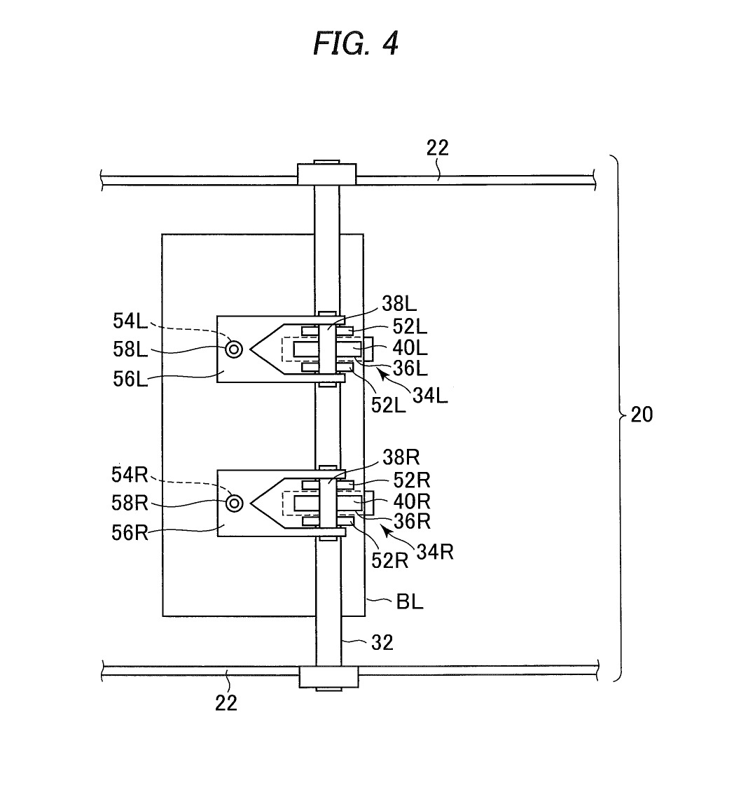

As shown in FIG. 3, with respect to the roller conveyance channel 20, the conveyance roller 34 is placed on the lower side thereof. The conveyance roller 34 rotates while touching one surface of a bill BL to transfer the latter. In the present embodiment, as shown in FIG. 4, there are two conveyance rollers 34R and 34L which are arranged side by side with an interval shorter than the length of the longer side of the bills BL so as to contact with the bills BL on the right and left portions thereof, respectively. The conveyance rollers 34R and 34L have a common axis forming a conveyance roller rotation shaft 32 as shown in FIG. 3, this shaft being a cylindrical shape having its opposite ends fixed to a frame 22 as shown in FIG. 4. The conveyance roller 34 is rotatable in a clockwise direction and a counterclockwise direction about the conveyance roller rotation shaft 32. Note that the frame 22 is refrained from showing in FIG. 3.

Above the conveyance rollers 34R and 34L, the pinch rollers 36R and 36L are provided so as to oppose the conveyance rollers, respectively. The pinch rollers 36R and 36L are adapted to be in contact with the other surface of the bill BL to press the bill BL from the side opposite to the corresponding conveyance roller 34 to transfer it, and comprise pinch roller shafts 38R and 38L and bearings 40R and 40L, respectively.

The pinch roller shafts 38R and 38L move the bearings 40R and 40L toward the conveyance rollers 34R and 34L so as to render the bearings 40R and 40L contact with the other surface of the bill BL. In the present embodiment, the pinch roller shafts 38R and 38L are arranged substantially in parallel to the conveyance roller rotation shaft 32. The bearings 40R and 40L contact with the other surface of the bill BL, i.e. the upper surface of the bill in FIGS. 3 and 4, on the outer periphery thereof, and rotate about the bearings 40R and 40L in the counterclockwise or clockwise direction according to a clockwise or counterclockwise rotation of the conveyance rollers 34 while pressing the bill BL from upper side, thus transferring the bill BL. In the present embodiment, the bearings 40R and 40L have cylindrical shape and penetration holes at the center thereof, through which the pinch roller shafts 38R and 38L penetrate to form the pinch rollers 36R and 36L. The maximum permissible dimension of the outer diameter of the pinch roller shaft 38 is made smaller than the minimum permissible dimension of the diameter of the penetration hole of the bearing 40, i.e. the inner diameter of the bearing 40, and thus the pinch roller shaft 38 and the bearing 40 are engaged into a so-called running fit.

As shown in FIG. 5, the pinch roller shaft 38R has its one end having a D-shaped cross section and forming a flat surface 42 which is generally flat, and its remaining portion formed cylindrical. Specifically, the cylinder has its upper portion, shown by a dotted line 70, cut out in depth and width directions to a position near above the center of the pinch roller shaft, i.e. the center of the cylinder 72, to form the flat surface 42. Similarly, the pinch roller shaft 38L has a flat surface which is generally flat, and is substantially the same as the flat surface 42, thus being designated with reference numerals in parentheses in FIG. 5. The flat surface of the pinch roller shaft 38L is formed at a position symmetrical to a position in which the flat surface 42 is formed in the pinch roller shaft 38R. As described above, the pinch roller shaft 38 has the planate flat surface 42 and a partial cylindrical surface 44 under the flat surface 42, that is, the outer periphery having its portion not deleted from the cylinder. A ridge line formed by the flat surface 42 and the circular surface 44 is referred to as a boundary 45.

Returning to FIG. 4, for the pinch rollers 36R and 36L, respectively arranged are pinch roller rails 52R and 52L, which are fixed to the frame 22 although not shown. The pinch roller rails 52R and 52L define routes along which the pinch roller shaft 38 are conducted when the pinch roller 36 moves toward the conveyance roller 34, that is, when the pinch roller shaft 38 moves to cause the bearing 40 to move toward the conveyance roller. In the instant embodiment, as shown in FIG. 3, the pinch roller rails 52R and 52L have the lateral side thereof formed into a U-shape with its top opened, thereby forming a shaft slider 50. The pinch roller shaft 38 moves on the shaft slider 50.

The shaft slider 50 has a front sliding surface 51f and a back sliding surface 51b, which are flat surfaces substantially parallel to each other. Hereinafter, the front sliding surface 51f and the back sliding surface 51b are also collectively referred to as a sliding surface 51. The distance from the front sliding surface 51f to the back sliding surface 51b, i.e. the width of the shaft slider 50, is slightly larger than the width of the pinch roller shaft 38. Accordingly, with the shaft slider 50, the pinch roller shaft 38 has its front end surface 68f moving on the front sliding surface 51f and its back end surface 68b moving on the back sliding surface 51b to slide in a shaft movable direction indicated by an arrow K, i.e. the vertical direction in the figure.

Returning to FIG. 4, bosses 54R and 54L (boss 54 in FIG. 3) are fixed to the frame 22, and near the upper end of the bosses 54R and 54L the pinch roller springs 56R and 56L (pinch roller spring 56 in FIG. 3), urging downward, are fixed by screws 58R and 58L (58 in FIG. 3). The pinch roller springs 56R and 56L abut on the pinch roller shaft and urge the latter. In the instant embodiment, each of the pinch roller springs is formed into a bifurcated plate spring having a U-shape when viewed from above as shown in FIG. 4, and has a spring flat surface 57 which is a generally flat surface as shown in FIG. 3.

By that structure, the pinch roller spring 56 causes the spring flat surface 57 to abut on the flat surface 42 of the pinch roller shaft 38 as shown in FIG. 3, and applies the spring urging force FSP to the pinch roller shaft 38 to urge the shaft 38 downward, thereby pushing the outer periphery of the bearing 40 supported by the pinch roller shaft 38 to the outer periphery of the conveyance roller 34. In FIG. 3, the spring urging force FSP is directed downward and is substantially parallel to a moving direction of the pinch roller shaft 38 in the shaft slider 50, i.e. parallel to the shaft movable direction K1. In this way, the bearing 40 of the pinch roller 36 is pushed against the conveyance roller 34 by the spring urging force FSP of the pinch roller spring 56, so that the pinch roller 36 rotates together with the conveyance roller 34 rotating (cooperative rotation). Note that the pinch roller may be urged not by the pinch roller spring but by any means, such as rubber, a magnet, or various other mechanisms.

As shown in FIG. 3, near the lower extreme of the pinch roller 36, an upper conveyance guide 60 runs through. The upper conveyance guide 60 has a plate shape having an opening, not shown, drilled at a position corresponding to the bearing 40 such as to pass the lower end of the bearing 40 so as to extend to the lower side of the upper conveyance guide 60.

In addition, substantially in parallel to the upper conveyance guide 60, a lower conveyance guide 62 runs through near the upper extreme of the conveyance roller 34. The lower conveyance guide 62 similarly has a plate shape having an opening, not shown, drilled at a position corresponding to the conveyance roller 34 such as to pass the upper end portion of the conveyance roller 34 to extend to the upper side of the lower conveyance guide 62. The upper conveyance guide 60 and the lower conveyance guide 62 can prevent the bills BL, while being pinched and conveyed by the pinch roller 36 and the conveyance roller 34, from being folded and bent.

In the roller conveyance channel 20 with above-described structure, the gap between the upper conveyance guide 60 and the lower conveyance guide 62 forms a bill conveyance channel 64 (part of the conveyance channel 7 shown in FIG. 2) which conveys the bills BL, and by the bill conveyance channel 64, the bills BL are conveyed towards right side from left side or toward left side from right side in the figure.

Next, with reference to FIG. 3, a detail description will be made on operation in the roller conveyance channel 20 when a bill BL is conveyed and comes to the roller conveyance channel 20 in the medium conveyance apparatus according to the present invention from the right side in the figure as indicated by an arrow B.

When a bill BL is conveyed, the pinch roller 36 is pushed toward the conveyance roller 34 by the pinch roller spring 56. The axis of the conveyance roller 34 has the conveyance roller rotation shaft 32 fixed to the frame 22, and therefore the conveyance roller 34 does not move even when pushed by the pinch roller 36. On the other hand, the pinch roller shaft 38 is slidable in the shaft slider 50, and therefore the pinch roller 36 moves upward against the spring urging force FSP only by a distance corresponding to the thickness of the bill BL. In this way, the bill BL is pinched from the upper and lower sides by the bearing 40 and the conveyance roller 34. After that, when the conveyance roller 34 rotates counterclockwise as indicated by an arrow C, the bearing 40 of the pinch roller 36 rotates clockwise as indicated by an arrow D while the conveyance roller 34 rotates to convey the bill BL in the direction indicated by the arrow B while pinching the bill BL by the conveyance roller 34 and the pinch roller 36.

At this time, since the bearing 40 of the pinch roller 36 rotates, while the conveyance roller 34 rotates, to be pushed against the conveyance roller 34 by the spring urging force FSP, the pinch roller shaft 38 receives the torque for the clockwise rotation, shown by an arrow E, from the bearing 40 by friction, and tends to rotate together with the bearing 40. However, according to the roller conveyance channel 20 in the medium conveyance apparatus of the present invention, the pinch roller shaft 38 does not rotate since the spring flat surface 57 of the pinch roller spring 56 urges the flat surface 42 of the pinch roller shaft 38 downward.

More specifically, although the flat surface 42 provides upward force to the spring flat surface 57 when the pinch roller shaft 38 tends to rotate, the flat surface 42 is urged downward by the spring flat surface 57 with the spring urging force FAP larger than the upward force, thus being pressed and held by the spring flat surface 57. Accordingly, the rotation of the pinch roller shaft 38 can be suppressed by the flat surface 42. Especially in the present embodiment, since the spring flat surface 57 being generally flat is in contact with the flat surface 42 also being generally flat, the surfaces 57 and 42 can be made in contact with each other in larger area, so that the pinch roller shaft 38 can much more be prevented from rotating.

Since the present invention can prevent the pinch roller shaft 38 from rotating in this way, it is possible to prevent the pinch roller shaft 38 from rotating and sliding in the shaft slider 50 to provide unnecessary force onto the pinch roller rail 52, and it is also possible to prevent the pinch roller shaft 38 from rotating in the penetration hole of the bearing 40 to delete the penetration hole of the bearing 40. In addition, the present invention prevents the upper end of the pinch roller shaft 38 from rubbing the pinch roller spring 56, and therefore the life of the pinch roller spring 56 and the pinch roller shaft 38 can be extended.

Further, in the present invention, since the spring urging force FSP of the pinch roller spring 56 which has been used is utilized to push the spring flat surface 57 against the flat surface 42, additional components are not needed to suppress the rotation of the pinch roller shaft 38, and it is possible to prevent the rotation of the pinch roller shaft 38 by a simple structure.

Still further in the present invention, the pinch roller shaft 38 has always its flat surface 42 kept to face the pinch roller spring 56 side and its circular surface 44 kept in contact with the sliding surfaces 51. Therefore, when sliding in the shaft slider 50, the circular surface 44, which is a round and smooth curved surface, can be contacted to the sliding surfaces 51, and it is thus possible to suppress the stress which the pinch roller shaft 38 and the sliding surfaces 51 receive. Accordingly, the automatic teller machine of the present invention can maintain the stable conveyance performance for a long period of time.

In the embodiment, the flat surface 42 of the pinch roller shaft 38 is formed as shown in FIG. 5 in the upper part than the center 72 of the cylinder, but the cylinder may be divided at the center 72 of the cylinder to form the flat surface 42 with the remaining lower half of the cylinder used as the circular surface 44, for example. In this case, since the flat surface 42 has the largest area, in which the flat surface 42 can contact with the spring flat surface 57, the rotation of the pinch roller shaft 38 can resultantly be suppressed most. However, the edge-like boundaries 45 forming boundary lines between the flat surface 42 and the circular surface 44 contact the sliding surfaces 51, and the boundaries 45 may delete the sliding surfaces 51 by friction whenever the pinch roller shaft 38 repetitively slides on the shaft slider 50, so that there is a possibility not to stably provide the conveyance performance for a long period of time. Accordingly, it is preferable to form the flat surface 42 such that the boundaries 45 do not contact with the sliding surfaces 51. Specifically, the flat surface 42 can be formed at a position slightly upper than the center 72 of the pinch roller shaft 38. By such a structure, the area of the flat surface 42 is enlarged as much as possible while stably ensuring the slidability between the pinch roller shaft 38 and the pinch roller rail 52, and the pinch roller shaft 38 can thereby be prevented from rotating.

Well, when using the roller bearing as before, in order to prevent the pinch roller shaft and the bearing from slipping with respect to each other and from shaking, use is made of the interference fit in which the minimum permissible dimension of the outer diameter of the pinch roller shaft is larger than the maximum permissible dimension of the inner diameter of the bearing, or the transition fit in which the minimum permissible dimension of the outer diameter of the pinch roller shaft is smaller than the maximum permissible dimension of the inner diameter of the bearing while the maximum permissible dimension of the outer diameter of the pinch roller shaft is larger than the minimum permissible dimension of the inner diameter of the bearing.

However, if the interference fit or transition fit were adopted in the present embodiment, almost all torque of the bearing 40 would directly be transmitted to the pinch roller rotation shaft 38. Accordingly, the instant embodiment adopting the running fit between the pinch roller shaft 38 and the bearing 40 makes the torque of the bearing 40 hard to be transmitted to the pinch roller shaft 38, and the pinch roller shaft 38 can thereby be more suppressed from rotating.

In this way, the medium conveyance apparatus of the present invention includes the conveyance roller, the shaft, the bearing and the shaft rotation suppression element, and the shaft is prevented from rotating by the shaft rotation suppression element. The medium conveyance apparatus can be used not only as a roller conveyance channel in automatic teller machines which transact in cash as with the present embodiment, but also as a conveyance machine or channel in apparatus with an appropriate purpose for conveying a sheet-like medium, for example, in an apparatus which handles thin paper sheets such as gift certificates, cash vouchers or admission tickets.

The medium transaction apparatus of the present invention includes the reception section, conveyance channel, conveyance roller, shaft, bearing and shaft rotation suppression element, and the shaft is prevented from rotating by the shaft rotation suppression element. Such medium transaction apparatus can be used not only as automatic teller machines which transact in cash as with the present embodiment, but also as a conveyance machine or channel in apparatus with an appropriate purpose for conveying a sheet-like medium, for example, as an apparatus which handles thin paper sheets such as gift certificates, cash vouchers or admission tickets.

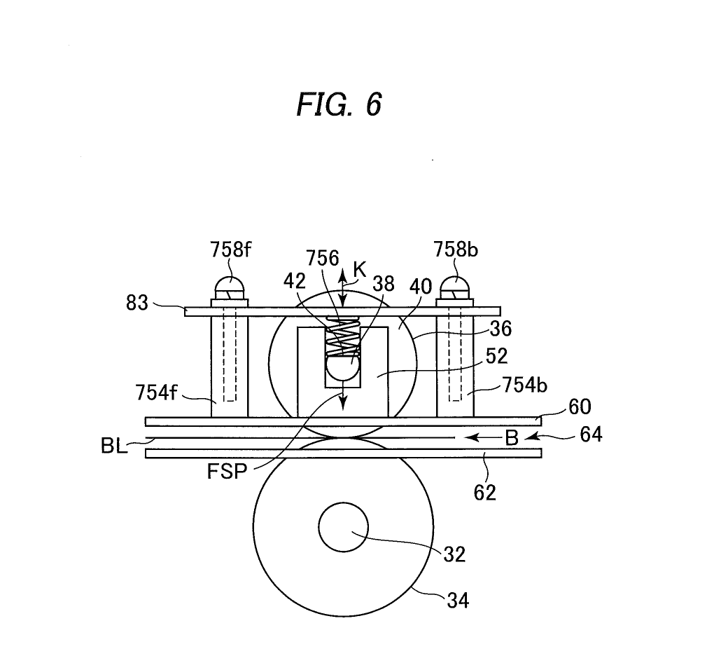

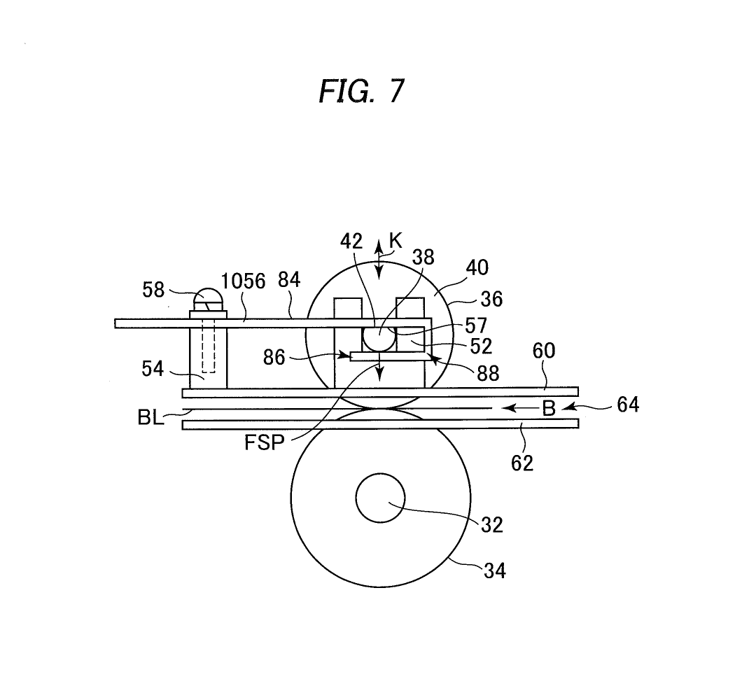

The instant embodiment exemplarily uses the pinch roller spring 56 configured by a plate spring, but an appropriate member suitable for the operating condition of the roller conveyance channel may be adopted as long as the member can urge the pinch roller in a predetermined direction. For example, a compression coil 756 may be applied as shown in FIG. 6, and a pinch roller spring 1056 may be applied as shown in FIG. 7. In FIGS. 6 and 7, parts corresponding to those in FIG. 3 are designated by the same reference numerals.

In FIG. 6, the pinch roller spring 56 is replaced by a pressing plate 83 and the compression coil 756. The pressing plate 83 is fixed to bosses 754 and 754b which are fixed to the frame 22 by screws 758f and 758b. The compression coil 756 is fitted in the shaft slider 50 such that one end thereof contacts with the pressing plate 83 and the other end contacts with the flat surface 42. Accordingly, by moving the pressing plate 83 in the shaft movable direction K to shorten the compression coil 756 from its natural length, it is possible to utilize a restoring force by which the compression coil 756 tends to return to its natural length to thereby urge downward the flat surface 42 of the pinch roller shaft 38. By that structure, the compression coil 756 can apply the spring urging force FSP more to the pinch roller shaft 38 than a case using the pinch roller spring 56 (FIG. 3), thus allowing the pinch roller shaft 38 to be more prevented from rotating.

In FIG. 7, the pinch roller spring 56 is replaced by a pressing plate 1056. The pinch roller spring 1056 is a plate spring which has its lateral side U-shaped, and has an upper arm 84, a lower arm 86 and a side arm 88. The upper arm 84 is a portion which extends horizontally above the pinch roller shaft 38 and has the spring flat surface 57, and has its one end fixed by a screw 58 on the upper end of the boss 54 and its other end continuing to the side arm 88. The side arm 88 is a portion which extends in the vertical direction, and has its upper end continuing to the upper arm 84 and its lower end continuing to the lower arm 86. The lower arm 86 is a portion which extends in the horizontal direction under the pinch roller shaft 38, and has its one end continuing to the side arm 88. The lower arm 86 has its part contact with the lower end of the pinch roller shaft 38.

The pinch roller spring 1056 thus structured can prevent the flat surface 42 from separating from the spring flat surface 57 even when a bill BL is jammed. Describing in detail, with the pinch roller spring 56 (FIG. 3), when a bill BL is jammed, unexpected external force is added to the pinch roller shaft 38, which in turn separately rotates from the spring flat surface 57 to deviate the flat surface 42 from the spring flat surface 57, thereby there being a possibility that it becomes difficult for the pinch roller spring 56 to prevent the pinch roller shaft 38 from rotating.

By contrast, since the pinch roller spring 1056 has the lower arm 86 contact with the lower end of the pinch roller shaft 38, it can prevent the pinch roller shaft 38 from moving downward to separate from the spring flat surface 57. Accordingly, it is possible to always urge the pinch roller shaft 38 downward by the spring flat surface 57 while preventing the pinch roller shaft 38 from rotating.

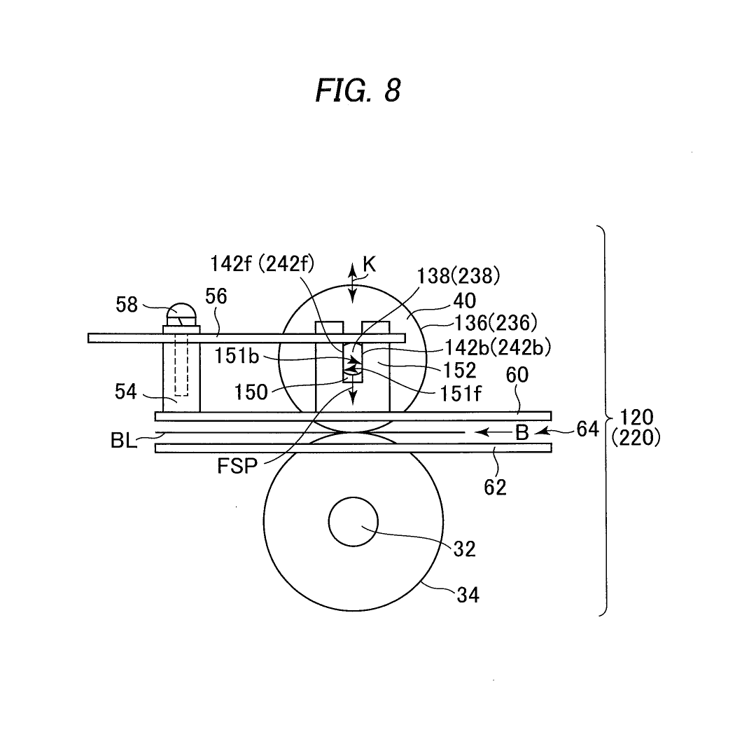

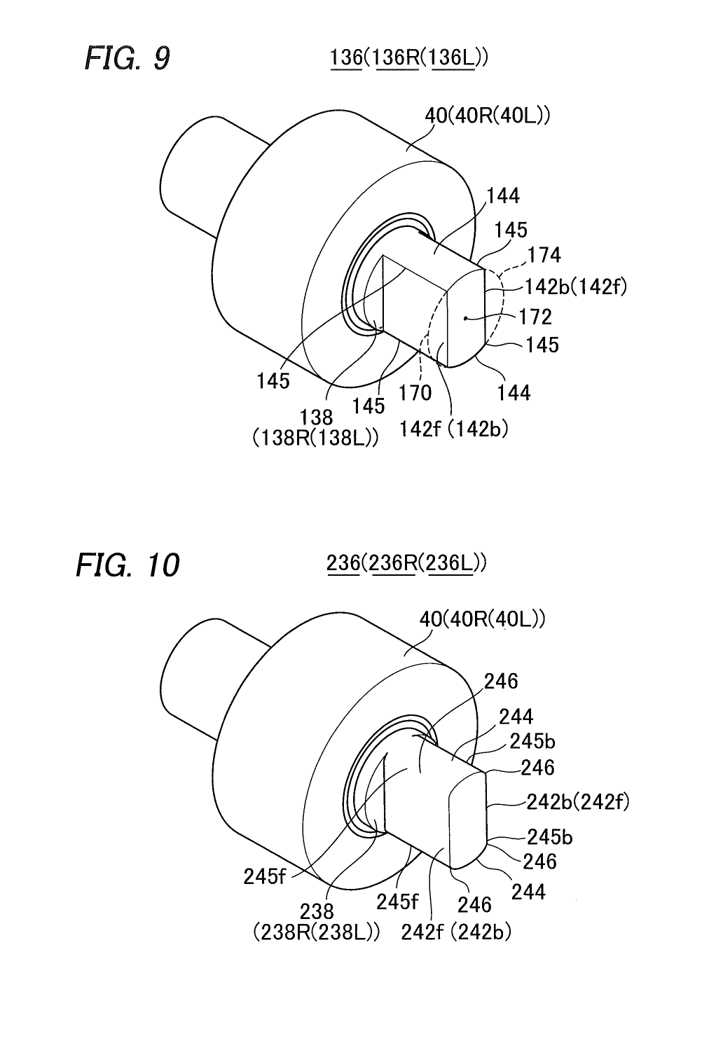

Next, with reference to FIGS. 8 and 9, a second embodiment of the medium conveyance apparatus and the medium transaction apparatus will be described according to the present invention. According to the second embodiment, an automatic teller machine 101 (FIGS. 1 and 2) is similarly structured to the automatic teller machine 1 according to the first embodiment except that a roller conveyance channel 120 is different from the roller conveyance channel 20.

As shown in FIG. 8 in which parts corresponding to those in FIG. 3 are designated by the same reference numerals, the roller conveyance channel 120 includes a pinch roller 136, a pinch roller shaft 138 and a pinch roller rail 152 which are respectively different from the pinch roller 36, the pinch roller shaft 3, and the pinch roller rail 52 according to the first embodiment.

As shown in FIG. 9, the pinch roller shaft 138 has its one end I-shaped in cross section and having a front flat surface 142f and a back flat surface 142b, and has its remaining portion cylindrical. Specifically, the cylinder has its one portion, depicted with a dotted line 170, cut off in depth and width directions to a position on the one side of the center 172 of the pinch roller shaft to form the front flat surface 142f, and has its opposite portion, depicted with a dotted line 174, cut off in depth and width directions to a position on the opposite side of the center 172 of the pinch roller shaft to form the back flat surface 142b. Both front and back flat surfaces 142f and 142b are generally flat, and are substantially parallel with each other. Hereinafter, the front and back flat surfaces 142f and 142b will collectively be referred to as a flat surface 142 also.

In this manner, the pinch roller shaft 138 includes the front flat surface 142f, the back flat surface 142b, and circular surfaces 144 between the front flat surface 142f and the back flat surface 142b, namely, the outer peripheries of the part not deleted from the cylinder. The ridge lines of the boundaries between the front flat surface 142f and the circular surfaces 144, and ridge lines of the boundaries between the back flat surface 142b and the circular surfaces 144 are referred to as a boundary 145.

The pinch roller shaft 138 thus structured slides in the shaft slider 150 of the pinch roller rail 152 as shown in FIG. 8. The shaft slider 150 has its width slightly longer than the distance from the front flat surface 142f to the back flat surface 142b of the pinch roller shaft 138. Accordingly, the pinch roller shaft 138 slides in the shaft movable direction K, so that the front flat surface 142f of the shaft 138 moves on the front sliding surface 151f and the back flat surface 142b moves on the back sliding surface 151b.

When a bill BL is conveyed to the roller conveyance channel 120 thus structured, for example, from backward as indicated by the arrow B, the pinch roller shaft 138 receives the torque from the bearing 40 by friction and tends to rotate together with the bearing 40. However, in the roller conveyance channel 120 in the medium conveyance apparatus according to the present invention, the front and back sliding surfaces 151f and 151b of the pinch roller rail 152 push from back and front the front and back flat surfaces 142f and 142b of the pinch roller shaft 138, respectively, so that the pinch roller shaft 138 would not rotate.

Especially in the present embodiment, since the front sliding surface 151f abuts against the front flat surface 142f while the back sliding surface 151b abuts against the back flat surface 142b, and all those surfaces are generally flat, the abutting faces are broader in area so as to more effectively preventing the pinch roller shaft 138 from rotating. Further, in the present embodiment, the surfaces 151f and 151b contact with the surfaces 142f and 142b, respectively, and the pinch roller shaft 138 can thus be prevented from rotating much more than when suppressing the rotation by the single surface 42 as shown in FIG. 3.

As have been described above, in the medium conveyance apparatus and the medium transaction apparatus of the present invention, the pinch roller shaft has the shaft rotation suppression function, and the sliding surfaces 51 of the slider contacts with the flat surfaces 142 of the pinch roller shaft 138 with a larger area so as to push the flat surfaces 142 from back and front, whereby it is possible to prevent the pinch roller shaft 38 from rotating together with the bearing when torque is transmitted to the pinch roller shaft 138 from the bearing 40.

Next, with reference to FIG. 10, a third embodiment of the medium conveyance apparatus and the medium transaction apparatus will be described according to the present invention. According to the third embodiment, an automatic teller machine 201 (FIGS. 1 and 2) is similarly structured to the automatic teller machine 101 according to the second embodiment except that a roller conveyance channel 220 is different from the roller conveyance channel 120.

As shown in FIG. 10 in which parts corresponding to those in FIGS. 8 and 9 are designated by the same reference numerals, the roller conveyance channel 220 includes a pinch roller 236 and a pinch roller shaft 238 which are respectively different from the pinch roller 136 and the pinch roller shaft 138 according to the second embodiment.

As shown in FIG. 10, the pinch roller shaft 238 has its one end I-shaped in cross section and having a front flat surface 242f and a back flat surface 242b, and has its remaining portion cylindrical. The pinch roller shafts 238 have its boundaries 245f and 245b chamfered, that is, boundaries between the front flat surface 242f and circular surfaces 244, and boundaries of the back flat surface 242b and circular surfaces 244, respectively, so as to form chamfers 246 of curved surface.

In the above-described structure, when a bill BL is conveyed as shown in FIG. 8, the pinch roller shaft 238 receives the torque from the bearing 40 by friction and tends to rotate together with the bearing 40. However, in the roller conveyance channel 220, the front and back sliding surfaces 151f and 151b of the pinch roller rail 152 respectively push from back and front the front and back flat surfaces 242f and 242b of the pinch roller shaft 238, so that the pinch roller shaft 238 would not rotate.

Especially in the present embodiment, since the chamfers 246 are formed in the pinch roller shaft 238, the pinch roller shaft 238 can smoothly move in the shaft movable direction K. Specifically, with the pinch roller shaft 138 (FIG. 9) according to the second embodiment, it could be possible that the edge shapes of the boundaries 145 would cause the boundaries 145 to catch or dig into the front sliding surface 151f or the back sliding surface 151b while the pinch roller shaft 138 slides in the shaft slider 150, so that the pinch roller shaft 138 could not smoothly move in the shaft movable direction, which would lead to lumbering motion. However, with the pinch roller shaft 238 shown in FIG. 10, the chamfer 246 prevents the boundaries of the shaft 238 from digging into the front sliding surface 151f and the back sliding surface 151b, and enables the shaft 238 to smoothly move in the shaft movable direction K. Accordingly, it is possible to extend the life of the pinch roller rail 152 and the pinch roller shaft 238, and to stably maintain the conveyance performance for a long period of time.

The chamfer 246 may be arbitrary in terms of the curvature of the curved surface and the amount of the chamfering. For example, as the amount of chamfering is increased by reducing the curvature to form smoother shapes of the boundaries 245f and 245b, the boundaries 245f and 245b become more difficult to dig into the front sliding surface 151f or the back sliding surface 151b. However, the front and back flat surfaces 242f and 242b would become smaller in area so that the front and back flat surfaces 242f and 242b would, respectively, become in contact with the front and back sliding surfaces 151f and 151b also with smaller area. As a result, it could become difficult for the pinch roller rail 152 to suppress the rotation of the pinch roller shaft 238. Accordingly, it is preferable to set the amount of chamfering and the curvature of the chamfers 246 such as to prevent the pinch roller shaft 238 from rotating while the pinch roller shaft 238 smoothly slides in the shaft slider 150.

As have been described above, in the medium conveyance apparatus and the medium transaction apparatus, the sliding surfaces 51 of the slider contacts with the flat surface 142 of the pinch roller shaft 138 with a larger area so as to catch the flat surface 142 from back and front, and it is thus possible to prevent the pinch roller shaft 38 from rotating and to cause the chamfer 246 to smoothly slide the pinch roller shaft 238 in the pinch roller rail 152.

Note that the chamfering may be processed onto any portions. For example, the chamfering may be processed on the boundaries 45 of the pinch roller shaft 38 having its cross section D-shaped as shown in FIG. 5, and on boundaries of a pinch roller shaft having other various shape, not illustrated, so as to chamfer the corner of the boundary into a curved surface. Alternatively, the chamfering may be processed on a flat surface, for example, whereby it is possible to make the angle of the edge of the boundary loose to thereby suppress friction between the sliding surfaces and the pinch roller shaft. Further, the chamfering can be processed only on the part where friction with the sliding surfaces is larger. For example, when description is made using the example of FIG. 10, the boundaries 245b on back side has larger friction against the sliding surface due to the horizontal component of the spring urging force FSP, and therefore the chamfering may be processed only on the boundaries 245b, thus reducing part of the chamfering when manufacturing the pinch roller shaft.

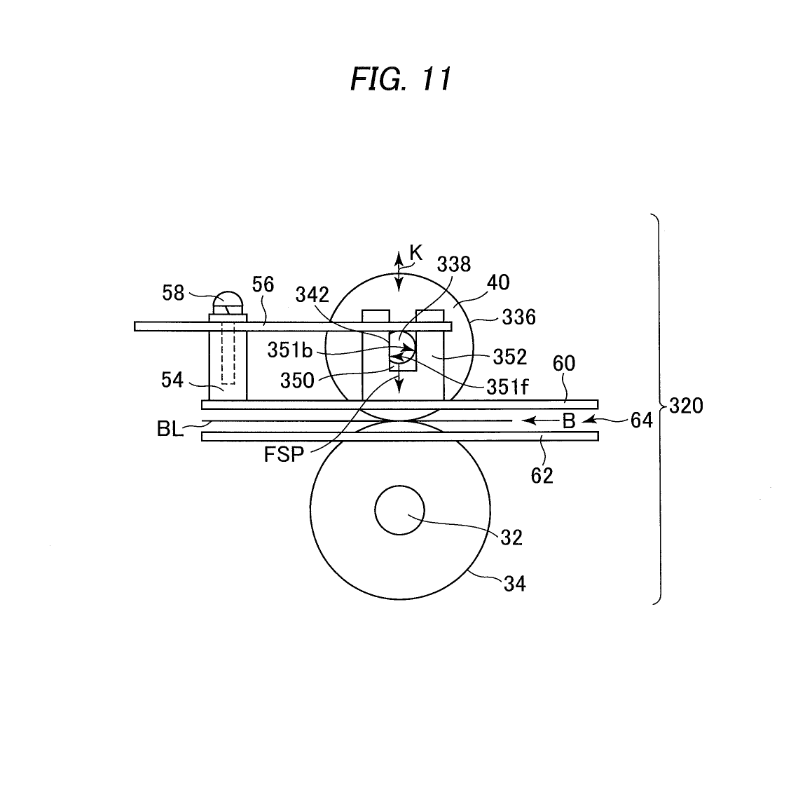

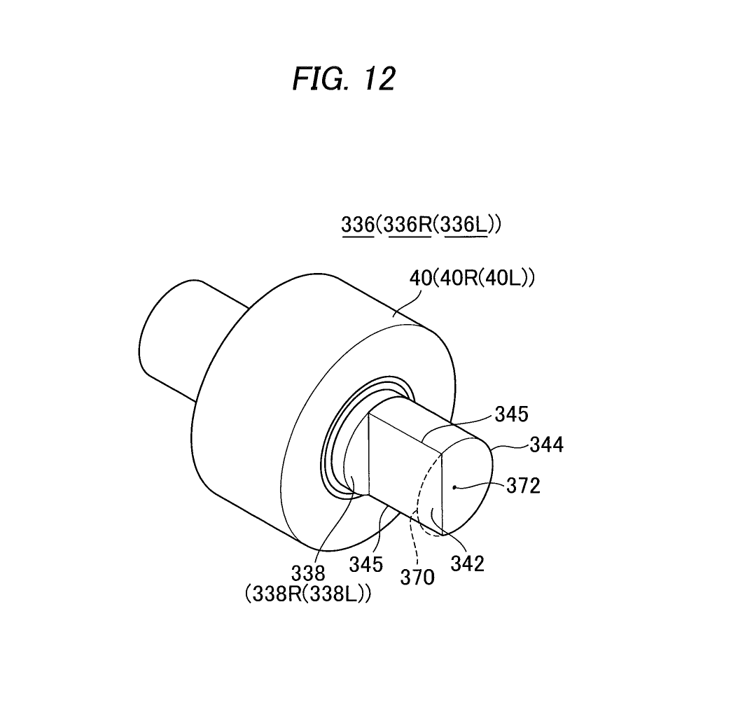

Next, with reference to FIGS. 11 and 12, a fourth embodiment of the medium conveyance apparatus and the medium transaction apparatus will be described according to the present invention. According to the fourth embodiment, an automatic teller machine 301 (FIGS. 1 and 2) is similarly constituted to the automatic teller machine 1 according to the first embodiment except that a roller conveyance channel 320 is different from the roller conveyance channel 20.

As shown in FIG. 11 in which parts corresponding to those in FIG. 3 are designated by the same reference numerals, the roller conveyance channel 320 includes a pinch roller 336, a pinch roller shaft 338 and a pinch roller rail 352 which are respectively different from the pinch roller 36 the pinch roller shaft 38 and the pinch roller rail 52 according to the first embodiment.

A shown in FIG. 12, the pinch roller shaft 238 has its shape which can be obtained by rotating the pinch roller shaft 38 (FIG. 5) 90 degrees counterclockwise. Specifically, a part of the cylinder depicted with a dotted line 370 is deleted in height and width directions to a position near the center 372 of the pinch roller shaft to form the flat surface 342. In this manner, the pinch roller shaft 338 has the flat surface 342, and a circular surface 344 behind the flat surface 42, that is, the outer periphery of the part not deleted from the cylinder.

The pinch roller shaft 338 thus formed slides in the shaft slider 350 of the pinch roller rail 352 as shown in FIG. 11. The shaft slider 350 has its width slightly longer than the horizontal distance from the flat surface 342 to the circular surface 344 of the pinch roller shaft 138. Accordingly, the pinch roller shaft 338 has its flat surface 342 moving on the front sliding surface 151f and has its circular surface 344 moving on the back sliding surface 151b to slide in the shaft movable direction K.

In the roller conveyance channel 320 having above-described structure, when a bill BL is conveyed, the torque is transmitted to the pinch roller shaft 338 from the bearing 40, so that the pinch roller shaft 338 tends to rotate together with the bearing 40. However, since the pinch roller shaft 338 has the flat surface 342 in a position which faces the front sliding surface 51f of the pinch roller rail 352, and the flat surface 342 is made to contact with the front sliding surface 51f, the pinch roller shaft 338 would not rotate. Especially in the present embodiment, the front sliding surface 151f, which is generally flat, is in contact with the flat surface 142, which is generally flat, so that the contact faces are broader in area, whereby the pinch roller shaft 338 can be prevented more extensively from rotating.

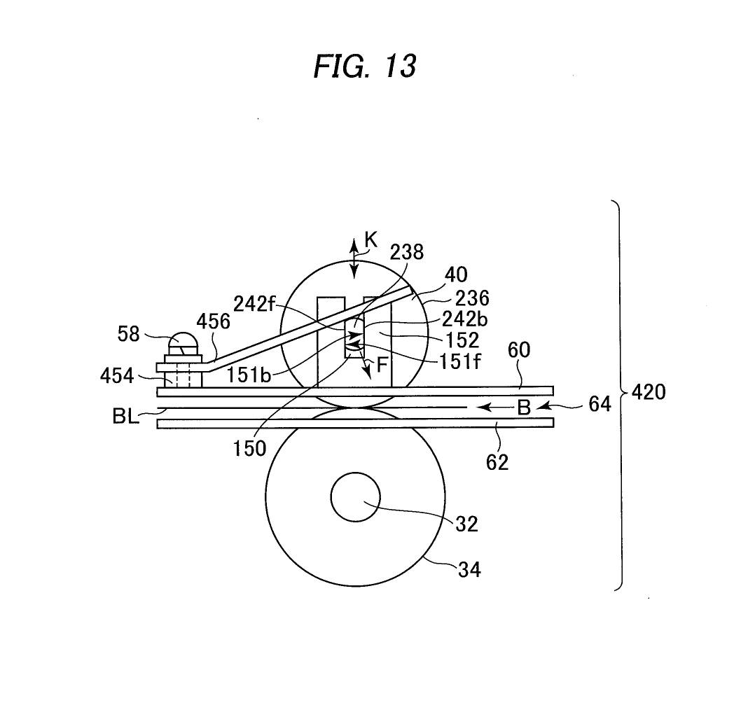

Next, with reference to FIG. 13, a fifth embodiment of the medium conveyance apparatus and the medium transaction apparatus will be described according to the present invention. According to the fifth embodiment, an automatic teller machine 401 (FIGS. 1 and 2) is similarly constituted to the automatic teller machine 201 according to the third embodiment except that a roller conveyance channel 420 is different from the roller conveyance channel 220.

As shown in FIG. 13 in which parts corresponding to those in FIG. 8 are designated by the same reference numerals, the roller conveyance channel 420 includes a boss 454 and a pinch roller spring 456 instead of the boss 54 and the pinch roller spring 56 according to third embodiment.

The boss 454 is vertically shorter than the boss 54 (FIG. 8) to thereby avoid interfering with the components of the automatic cash dispenser 401 arranged around the roller conveyance channel 420. The pinch roller spring 456 is inflected once near the boss, and has its one end fixed near an upper end of the boss 454 by the screw 58 and its other end contact with a position that is a little bit closer to the boss 454 from the upper end point of the pinch roller shaft 238. That allows the pinch roller spring 456 to apply urging force obliquely downward to the pinch roller shaft 238, as indicated by an arrow F in FIG. 13, so that the spring urging force FSP turns to a direction inclined with respect to the shaft movable direction K.

In the roller conveyance channel 420 having above-described structure, when a bill BL is conveyed over the bill conveyance channel 64, since the torque is transmitted to the pinch roller shaft 238 from the bearing 40, the pinch roller shaft 238 tends to rotate together with the bearing 40. However, the front and back sliding surfaces 151f and 151b of the pinch roller rail 152 respectively push from back and front the front and back flat surfaces 242f and 242b of the pinch roller shaft 238, whereby the pinch roller shaft would not rotate.

Especially in the roller conveyance channel 420, the pinch roller spring 456 urges so as to push the pinch roller shaft 238 against the back sliding surface 151b. It is therefore possible to avoid interference with the surrounding components, and, in addition, in comparison with the roller conveyance channel 22 (FIG. 8) according to the third embodiment, it is possible to enlarge friction between the back flat surface 242b of the pinch roller shaft 238 and the back sliding surface 151b of the pinch roller rail 152 when the pinch roller shaft 238 slides in the shaft slider 150 whereby the pinch roller shaft 238 can much more be prevented from rotating together with the bearing 40.

Since the pinch roller spring 456 urges to push the back flat surface 242b of the pinch roller shaft 238 against the back sliding surface 151b, it is preferable to provide the pinch roller shaft 238 with the chamfer 246 as shown in FIG. 10 in detail. Specifically, with the roller conveyance channel 420, among the boundaries 245f and 245b of the pinch roller shaft 238, the boundaries 245b, particularly the lower boundary 245b, exclusively receive the spring urging force FSP and the torque from the bearing 40, and it is therefore preferable to chamfer at least the lower boundary 245b.

Not only by chamfering the boundaries of the pinch roller shaft, but also by generally smoothing the contacting part in which the pinch roller spring and/or the pinch roller rail contacts and/or contact with the pinch roller shaft, and/or by oil-lubricating the contacting part, it is possible to reduce the friction of the contacting part. In this way, even when the spring urging force FSP includes a force component in a direction which is different from the shaft movable directions K, the influence from the component can be reduced.

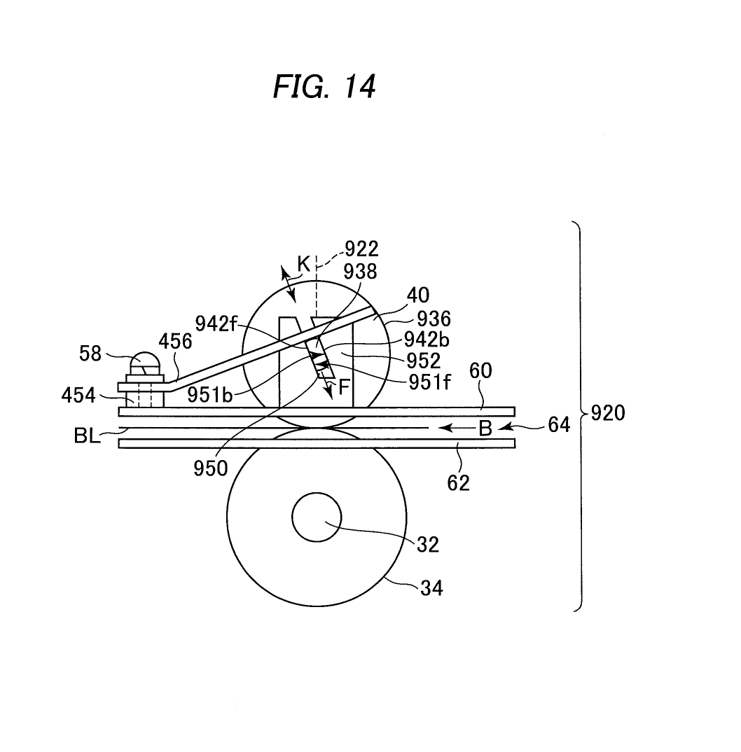

FIG. 13 shows the front and back sliding surfaces 151f and 151b are substantially perpendicular to the face of the bills BL. The present invention is however not limited to this but, for example, those may be inclined as shown in FIG. 14. The roller conveyance channel 920 shown in FIG. 14 has its front and back sliding surfaces 951f and 951b inclined with respect to the vertical direction 922, more specifically, formed such that the shaft movable direction K is substantially the same as a direction F of the spring urging force FSP of the pinch roller spring 456.

In FIG. 14, the pinch roller shaft 938 has its front and back flat surfaces 942f and 942b substantially in parallel correspondingly to the inclined front and back sliding surfaces 951f and 951b, respectively. Accordingly, when the pinch roller shaft 938 slides in the shaft slider 950, it is possible to prevent the boundaries 145 of the pinch roller shaft 938 from digging into the front and back sliding surfaces 951f and 951b of the pinch roller rail 952, thereby avoiding an excessive stress incurred to the pinch roller shaft 938.

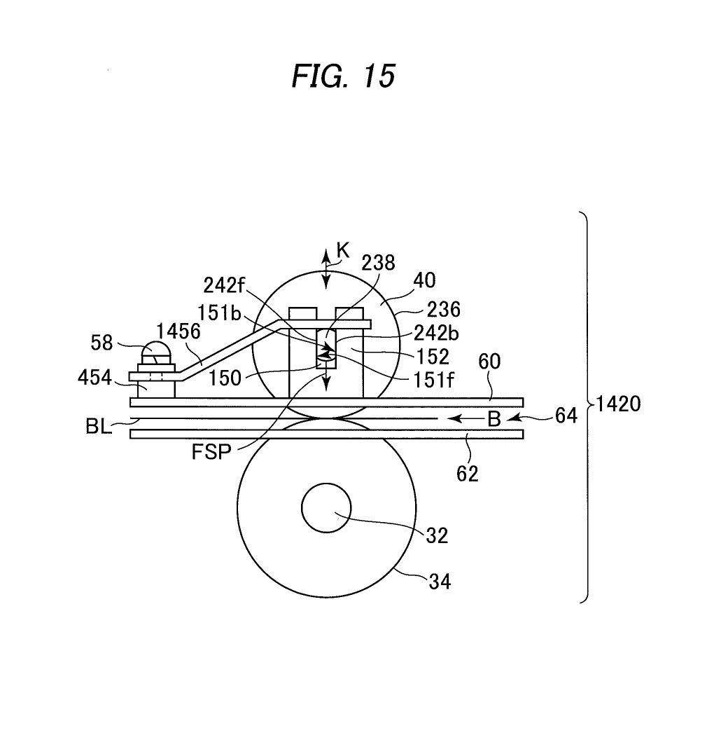

In addition, as shown in FIG. 15, it is also possible to further inflect a part of the pinch roller spring 456. In FIG. 15, instead of the pinch roller spring 456, use is made of a pinch roller spring 1456 which is inflected at two or more portions. The pinch roller spring 1456 is inflected at two portions, one end of which is fixed near the upper end of the boss 454 by the screw 58, and the other end has a horizontally-extended shape to be in contact with the entire upper end of the pinch roller shaft 238.

Accordingly, the pinch roller spring 1456 applies the spring urging force FSP substantially in the vertical direction to the pinch roller shaft 238, rather than the spring urging force FSP in the oblique direction as shown in FIGS. 13 and 14. That allows the pinch roller shaft 238 to smoothly slide in the shaft slider 150 in the shaft movable direction K.

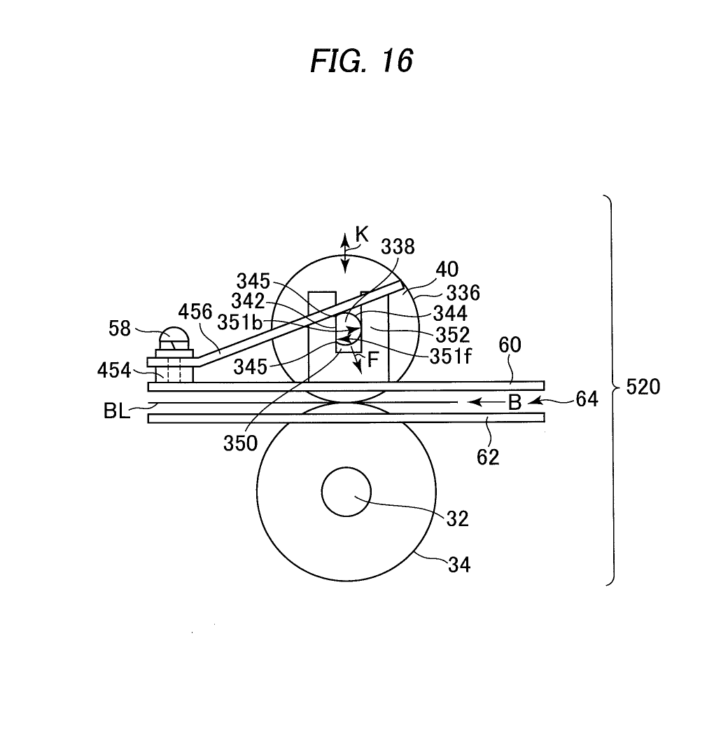

Next, reference will be made to reference to FIG. 16 for describing a sixth embodiment of the medium conveyance apparatus and the medium transaction apparatus according to the present invention. According to the sixth embodiment, an automatic teller machine 501 (FIGS. 1 and 2) is similarly constituted to the automatic teller machine 401 according to the fifth embodiment except that a roller conveyance channel 520 is different from the roller conveyance channel 420.

As shown in FIG. 16 in which parts corresponding to those in FIG. 13 are designated by the same reference numerals, the roller conveyance channel 520 includes, instead of the pinch roller 236, the pinch roller shaft 238 and the pinch roller rail 152 according to the fifth embodiment, the pinch roller 336 and the pinch roller shaft 338 shown in FIGS. 11 and 12 and the pinch roller rail 352 shown in FIG. 11.

Accordingly, since the pinch roller spring 456 applies the spring urging force FSP in the lower right direction in the figure as indicated by the arrow F, friction caused, when the pinch roller shaft 338 slides in the shaft slider 350, between the back end of the circular surface 344 of the pinch roller shaft 338 and the back sliding surface 351b of the pinch roller rail 352 is larger than the roller conveyance channel 320 (FIG. 11) according to the fourth embodiment. However, since the circular surface 344 is shaped into a curved surface, the pinch roller shaft 338 can smoothly move in the shaft movable direction K without causing the back end of the circular surface 344 to dig into the back sliding surface 351b.

Note that the pinch roller spring 456 applies the horizontal component of the spring urging force thereof to the circular surface 344 side of the pinch roller shaft 338, and therefore friction caused, when the pinch roller shaft 338 slides in the shaft slider 350, between the flat surface 342 of the pinch roller shaft 338 and the front sliding surface 351f of the pinch roller rail 352 is smaller than the roller conveyance channel 320 (FIG. 11). Accordingly, even when the boundaries 345 of the pinch roller shaft 338 have edge shapes, the boundaries 345 do not easily dig into the front sliding surface 351f of the pinch roller rail 352. Thus, it is possible to avoid chamfering when manufacturing the pinch roller shaft 338. Needless to say, use may be made of the pinch roller shaft 338 has its boundaries 345 chamfered.

In the roller conveyance channel 520 according to the sixth embodiment, in order to avoid interference with the surrounding components, the pinch roller spring 456 urges to push the pinch roller shaft 338 against the back sliding surface 351b of the pinch roller rail 352. However, the circular surface 344 is shaped into a curved surface and therefore the pinch roller shaft 338 can smoothly slide in the shaft slider 350 without digging into the back sliding surface 351b of the pinch roller rail 352.

In addition, according to the sixth embodiment, when manufacturing the pinch roller shaft 338, not only the chamfering can be omitted as described above, but also flattening for one flat surface can be omitted in comparison with the pinch roller shaft 238 according to the fifth embodiment since the pinch roller shaft 338 has its cross-section D-shaped, and thus the manufacturing process can more be simplified.

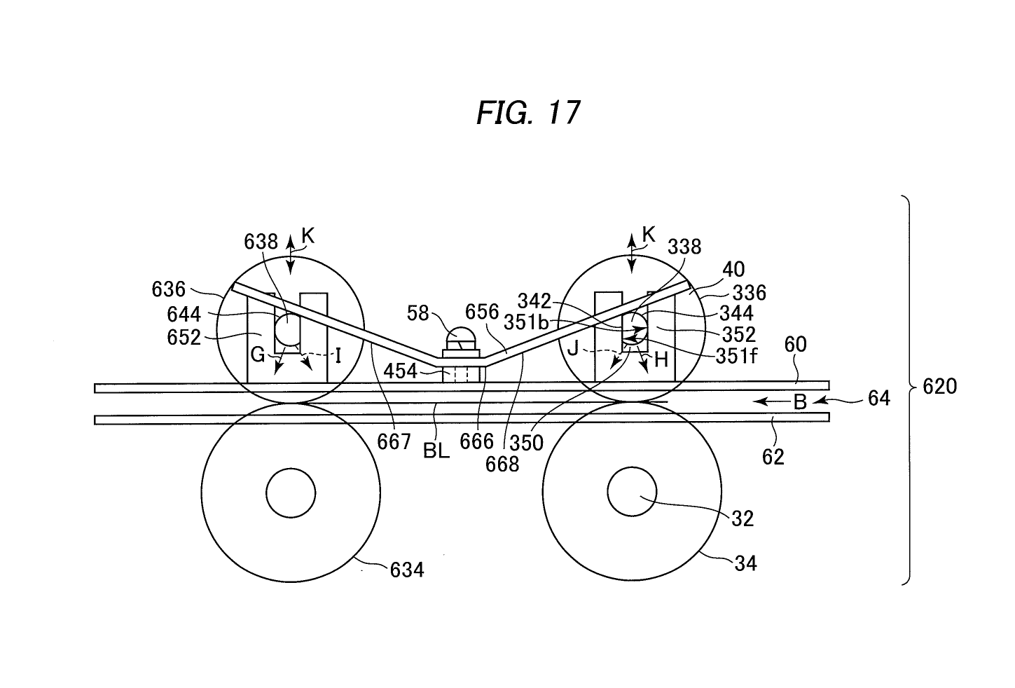

Next, reference will be made to FIG. 17 for describing a seventh embodiment of the medium conveyance apparatus and the medium transaction apparatus according to the present invention. According to the seventh embodiment, an automatic teller machine 601 (FIGS. 1 and 2) is similarly constituted to the automatic teller machine 501 according to the sixth embodiment except that a roller conveyance channel 620 is different from the roller conveyance channel 520.

As shown in FIG. 17 in which parts corresponding to those in FIG. 16 are designated by the same reference numerals, the roller conveyance channel 620 includes a pinch roller spring 656 instead of the pinch roller spring 456 according to the sixth embodiment, as well as a conveyance roller 634, a pinch roller 636 and a pinch roller rail 652 additionally. The conveyance roller 634, the pinch roller 636 and the pinch roller rail 652 are arranged so as to be symmetrical to the conveyance roller 34, the pinch roller 336 and the pinch roller rail 352 with respect to the boss 454 in the conveyance direction of the bills BL indicated by the arrow B.

The pinch roller spring 656 is a plate spring, and has its center serving as a fixer 666, and a first and a second arm 667 and 668 which extend from the fixer 666 to the pinch roller shafts 638 and 338, respectively, with the fixer 666 screwed to the boss 454 by the screw 58. The boss 454 is fixed to the frame 22. The first arm 667 of the pinch roller spring 656 contacts, at an end opposite to the fixer 666, with a position of the pinch roller shaft 638 which is a little bit closer to the fixer from the upper end of the pinch roller shaft 638 to apply the spring urging force indicated by an arrow G to the pinch roller shaft 638. Similarly, the second arm 668 of the pinch roller spring 656 contacts, at an end opposite to the fixer 666, with a position of the pinch roller shaft 338 which is a little bit closer to the fixer 666 from the upper end of the pinch roller shaft 338 to apply the spring urging force indicated by an arrow H to the pinch roller shaft 338.

In this manner, in the roller conveyance channel 620, the single pinch roller spring 656 allows a couple of pinch roller shafts arranged forward and backward in the conveyance direction 120 of bills BL to be urged. Therefore, the addition of the conveyance roller 634, the pinch roller 636 and the pinch roller rail 652 still makes it possible to prevent the bosses, pinch roller springs and screws from being increased in number, and to miniaturize the entire size of the roller conveyance channel 620.

Note that the boss 454 shown in FIG. 17 may be made taller so as to use a pinch roller spring (not shown) having a shape which is obtained by vertically inverting the pinch roller spring 656. In that case, the first arm 667 extends downward from the fixer 666 to contact with the pinch roller shaft 638, and applies the spring urging force as indicated by an arrow I to the shaft 638. Similarly, the second arm 668 extends downward from the fixer 666 to contact with the pinch roller shaft 338, and applies the spring urging force as indicated by an arrow J to the shaft 338. Accordingly, it is desirable to orient the pinch roller shafts 638 and 338 opposite by 180 degrees to the states shown in FIG. 17. Specifically, it is preferable to arrange the shaft 638 such that the circular surface 644 thereof faces the fixer 666 side, and to arrange the shaft 338 such that the circular surface 344 thereof faces the fixer 666 side. According to such structure, since the pinch roller shafts 338 and 638 have the circular surfaces 344 and 644 thereof pushed against the pinch roller rails 362 and 652, respectively, they can slide without being caught in the pinch roller rails 362 and 652.

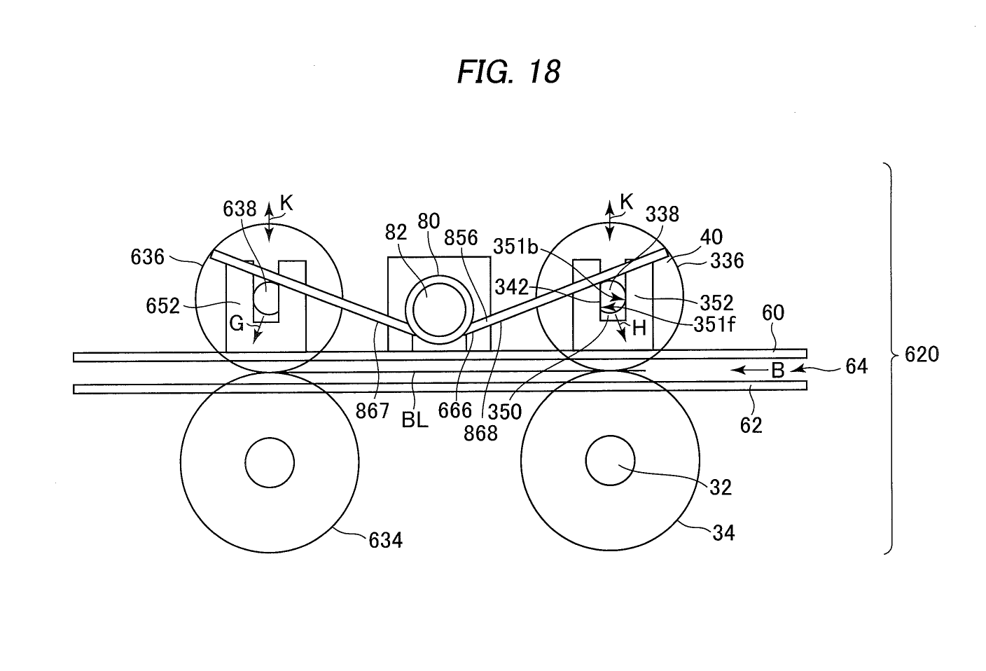

When urging a couple of pinch roller shafts by a single pinch roller spring, not only a plate spring but arbitrary pinch roller springs can be employed. For example, as shown in FIG. 18, a torsion spring 856 may be adopted instead of the pinch roller spring 656.

In FIG. 18, the torsion spring 856 has its center serving as a winder 80 which is a spring shaft, and a first and a second arm 867 and 868 which respectively extend to the pinch roller shafts 638 and 338 from the winder 80, the winder being fixed on the spring shaft 82 by winding. The first arm 867 contacts, at an end opposite to the winder, with a position of the pinch roller shaft 638 which is a little bit closer to the winder 80 from the upper end of the pinch roller shaft 638. The second arm similarly contacts, at an end opposite to the winder 80, with a position of the pinch roller shaft 338 which is a little bit closer to the winder 80 from the upper end of the pinch roller shaft 638.

When the torsion spring 856 tends to return to its natural state, the first arm 867 urges the pinch roller 636 by the urging force applied obliquely downward as indicated by the arrow G to the pinch roller shaft 638, and the second arm 868 similarly urges the pinch roller 336 by the urging force applied obliquely downward as indicated by the arrow H to the pinch roller shaft 338. Even when a single pinch roller spring is used to urge a couple of pinch roller shafts, it is needless to say that the pinch roller shafts may be urged in arbitrary direction. For example, only the vertical urging force may be applied.

As have been described above, in the present invention, the pinch roller shaft has the function of suppressing shaft rotation, thereby preventing the pinch roller shaft from rotating together with the bearing. So long as the pinch roller shaft has at least one surface which contacts with the pinch roller spring or the pinch roller rail, the pinch roller shaft may be of an arbitrary shape, and it may be of a triangle and a quadrangle.

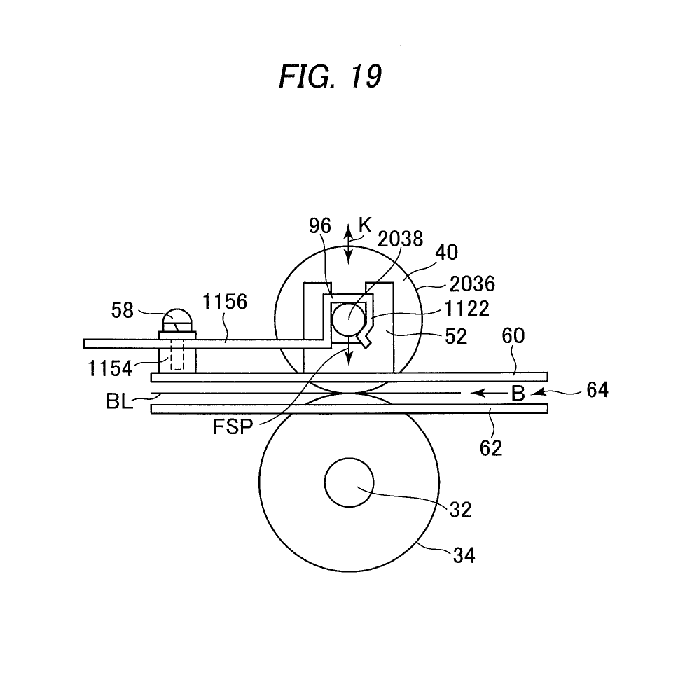

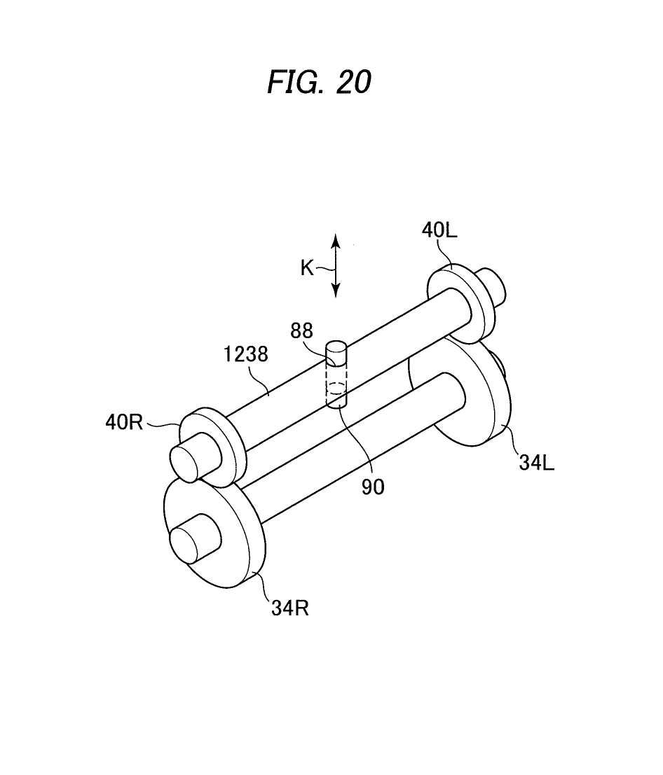

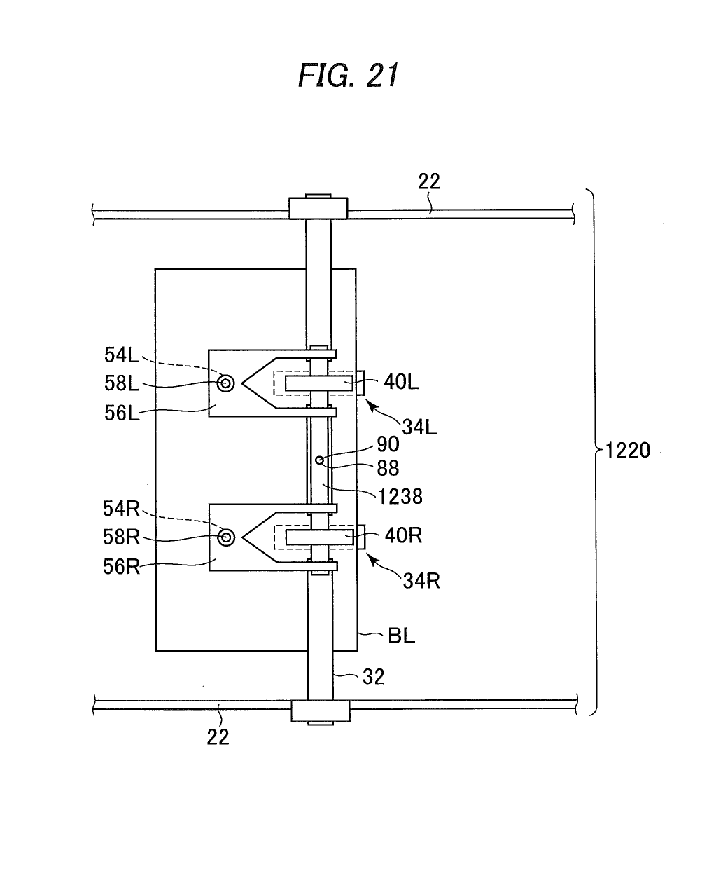

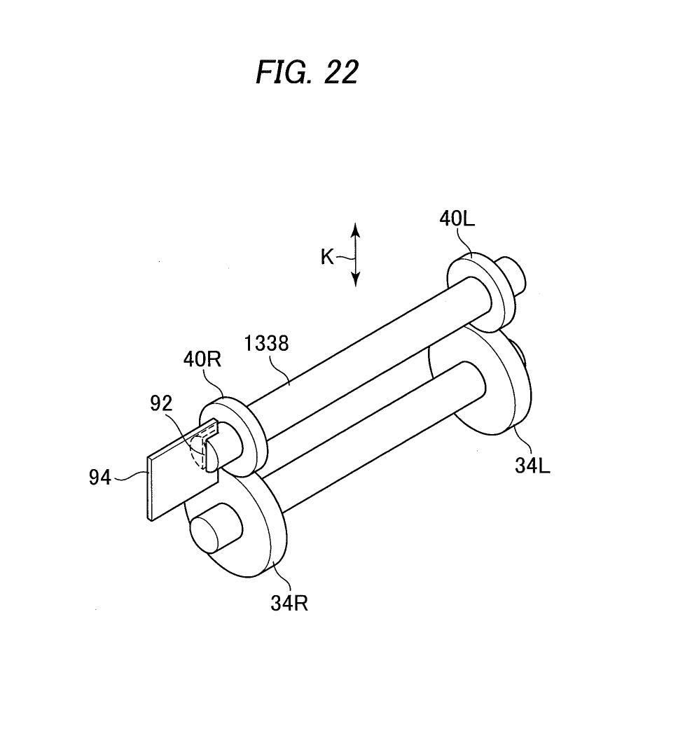

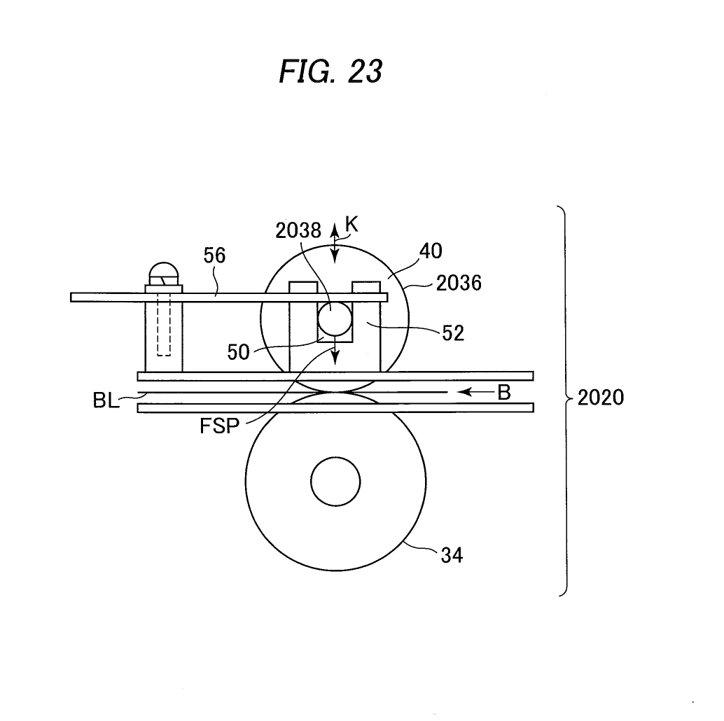

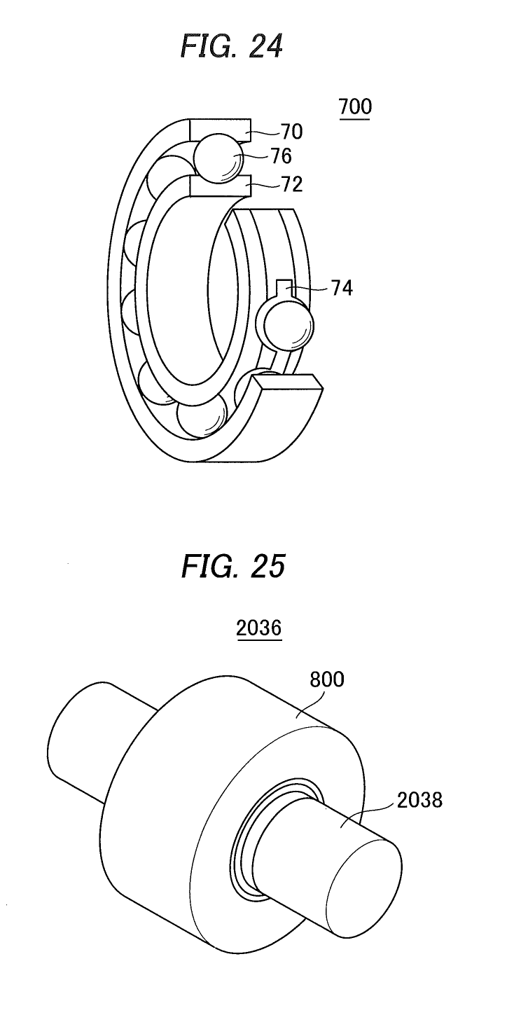

For example, as shown in FIG. 19, the pinch roller spring may have a function of suppressing the shaft rotation, and alternatively, as shown in FIGS. 20 to 22, it may be possible to additionally provide a member for functioning to suppress the shaft rotation. In FIG. 19, parts corresponding to those in FIG. 23 are designated by the same reference numerals, and in FIGS. 20 and 21, parts corresponding to those in FIGS. 3 and 4 are designated by the same reference numerals, and in FIG. 22, parts corresponding to those in FIG. 3 are designated by the same reference numerals. In those figures, the pinch roller shaft is cylindrical.

In FIG. 19, the pinch roller spring 1156 suppresses the rotation of the pinch roller shaft. Describing specifically, the pinch roller spring 1156 has its one end screwed near the upper end of the boss 1154 by the screw 58 to urge downward, and its other end forming a hook 96. The hook 96 is inflected to have its lateral side U-shaped so as to open downward. The hook 96 includes apiece 1122 inflected inward the opening, and the piece 1122 is in contact with the lower surface of the pinch roller shaft 2038. Accordingly, the pinch roller spring 1156 holds the pinch roller shaft 2038 so as to surround the latter by the hook 96 to thereby prevent the rotation of the pinch roller shaft 2038.

As an approach for leading the pinch roller shaft 2038 to the opening of the hook 96, an example can be given where the pinch roller spring 1156 is moved to abut the opening of the hook 96 to the pinch roller shaft 2038, and slightly widen the opening by means of elastic force to lead the pinch roller shaft 2038 into the hook 96.

With reference to FIGS. 20 and 21,elements 88 and 90 for suppressing the rotation of the pinch roller shaft are provided on the pinch roller shaft 1238 and the frame 22, respectively, thereby preventing the rotation of the pinch roller shaft 1238. Describing specifically, the pinch roller shaft 1238 has a penetration hole 88 drilled at its center. The penetration hole 88 has a cylindrical shape to form a hole bored in a direction substantially parallel to the shaft movable direction K (substantially vertical direction in FIGS. 20 and 21), a guidepost 90 being inserted therethrough as shown in FIG. 20. The post 90, which is cylindrical to extend substantially in the vertical direction, has its diameter slightly smaller than the diameter of the penetration hole 88, and is fixed to the frame 22 as shown in FIG. 21. FIG. 20 omits from illustration components other than the conveyance rollers 34R and 34L, the bearings 40R and 40L, the pinch roller shaft 1238, the penetration hole 88 and the guidepost 90. The pinch roller shaft 1238 may move in the shaft movable direction K in response to the penetration hole 88 moving along the guidepost 90. Therefore, the roller conveyance channel 1220 does not require a pinch roller rail as seen from FIG. 21.

In the roller conveyance channel 1220, when the torque from the bearing 40R and 40L is transmitted to the pinch roller shaft 1238, the pinch roller shaft 1238 resists the torque by means of the penetration hole 88 and the guidepost. Specifically, the pinch roller shaft 1238 causes the inner periphery of the penetration hole 88 to contact with the outer periphery of the guidepost 90, thereby preventing a rotation.

In FIG. 22, the pinch roller shaft 1338 has its one end surface having a straight notch slot 92 cut substantially in the vertical direction of the pinch roller shaft 1338, and the notch slot 92 receives a plate-like guide plate 94, the thickness of which is a little bit thinner than the width of the slot 92. The pinch roller shaft 1338 can move in the shaft movable direction K in response to the notch slot 92 moving along the guide plate 94 to move the bearings 1340R and 1340L in the shaft movable direction K. It is possible to resist the torque from the bearings 1240R and 1240L by engaging the guide plate 94 with the notch slot 92. Note that, since the pinch roller shaft 1338 can move in the shaft movable direction K in response to the notch slot 92 moving along the guide plate 94, it does not require a pinch roller rail. Accordingly, the pinch roller shaft 1338 can be employed instead of the pinch roller shaft 1238 in the roller conveyance channel 1220 shown in FIG. 21. In that case, the guide plate 94 is fixed to the frame 22, although not illustrated. It is needless to say that the shaft rotation suppression element may be formed into arbitrary structures at arbitrary places as long as the shaft rotation suppression element can suppress the rotation of the pinch roller shaft.

The entire disclosure of Japanese patent application No. 2011-206133 filed on Sep. 21, 2011, including the specification, claims, accompanying drawings and abstract of the disclosure, is incorporated herein by reference in its entirety.

While the present invention has been described with reference to the particular embodiments, it is not to be restricted by the embodiments. It is to be appreciated that so-called those skilled in the art can change or modify the embodiments, without departing from the scope and spirit of the present invention.

1. A medium conveyance apparatus comprising:
a conveyance roller rotatably provided on a rotation shaft, and contacting with one surface of a sheet-like medium to convey the medium;
a bearing provided opposite to said conveyance roller, and contacting with another surface of the medium to rotate while said conveyance roller rotates;
a shaft arranged substantially in parallel to the rotation shaft of said conveyance roller to move said bearing toward said conveyance roller; and
a shaft rotation suppression element suppressing said shaft from rotating together with said bearing.

2. The medium conveyance apparatus in accordance with claim 1, further comprising:
a shaft sliding member forming a route along which said shaft moves said bearing toward said conveyance roller; and
an urging member urging said shaft toward said conveyance roller,
said shaft being urged by the urging member to move along said shaft sliding member,
said shaft rotation suppression element being at least one generally flat surface provided on said shaft to contact with said urging member or said shaft sliding member.

3. The medium conveyance apparatus in accordance with claim 2, wherein said urging member urges said shaft in a direction different from a moving direction of said shaft along said shaft sliding member.

4. The medium conveyance apparatus in accordance with claim 3, wherein
said shaft rotation suppression element comprises generally flat first and second surfaces provided on said shaft to contact with said shaft sliding member, said first surface and said second surface being substantially parallel to each other,
said shaft sliding member having a third surface contacting with said first surface and a fourth surface contacting with said second surface, said third surface and said fourth surface being generally flat.

5. The medium conveyance apparatus in accordance with claim 2, wherein
the generally flat surface contacts with said shaft sliding member,
said shaft sliding member having a generally flat surface contacting with the surface.

6. The medium conveyance apparatus in accordance with claim 5, wherein
the generally flat surface comprises two surfaces substantially parallel to each other,
said shaft sliding member having two generally flat surfaces contacting with the surfaces.

7. The medium conveyance apparatus in accordance with claim 2, wherein
the generally flat surface contacts with said urging member,
said urging member having a generally flat surface contacting with the surface.

8. The medium conveyance apparatus in accordance with claim 2, wherein said shaft has a curved surface on an opposite side of the generally flat surface.

9. The medium conveyance apparatus in accordance with claim 2, wherein the generally flat surface has an end at least partially chamfered.

10. The medium conveyance apparatus in accordance with claim 2, wherein said shaft is fit into said bearing by a running fit.

11. A medium transaction apparatus comprising:
a reception section receiving a transaction on a sheet-like medium; and
a conveyance channel conveying the medium received by said reception section,
said conveyance channel further comprising:
a conveyance roller rotatably provided on a rotation shaft, and contacting with one surface of the medium to convey the medium;
a bearing provided opposite to said conveyance roller, and contacting with another surface of the medium to rotate while said conveyance roller rotates;
a shaft arranged substantially in parallel to the rotation shaft of said conveyance roller to move said bearing toward said conveyance roller; and
a shaft rotation suppression element suppressing said shaft from rotating together with said bearing.
